(19) United States
(12) Patent Application Publication
(10) Pub. No.: US 2021/0233137 A1
(43) Pub. Date: Jul. 29, 2021

(54) System and Methods of Providing Date-Specific Personalized Souvenirs

(71) Applicant: Orion Photo Industries, Inc., Prescott, AZ (US)

(72) Inventor: David Mudrick, Prescott, AZ (US)

(21) Appl. No.: 17/162,640

(22) Filed: Jan. 29, 2021

Related U.S. Application Data
(60) Provisional application No. 62/967,211, filed on Jan. 29, 2020.

(51) Int. Cl. G06Q 30/06; G09F 9/35; A44B 15/00

(52) U.S. Cl. CPC G06Q 30/0621; A44B 15/00; G09F 9/35

(57) ABSTRACT

A method for providing a date-specific personalized souvenir is disclosed. The method may include the steps of contacting a souvenir retailer, optionally preparing artwork, which may include date-specific artwork and information, selecting dates for a date-specific personalization of the souvenirs, providing a rack to the souvenir retailer for displaying the souvenirs, and servicing the racks to ensure that the rack is maintained with the proper inventory.

### CROSS REFERENCE TO RELATED APPLICATIONS

This application claims the benefit of and priority to U.S. Provisional Application No. 62/967,211, filed Jan. 29, 2020. The entire specification and figures of the above-referenced application are hereby incorporated, in their entirety by reference.

### FIELD OF THE INVENTION

The inventive technology disclosed herein relates to method of supplying date-specific souvenirs, and more particularly to a method for providing and servicing a date-specific personalized souvenir program.

### BACKGROUND OF THE INVENTION

Souvenirs and souvenir programs are known in the art. Such commercial items are generally directed to consumers visiting new or exciting destinations throughout the world, or attending a specific event or function, such as a concert or corporate gathering. In most instances such personalized souvenirs may include a personal or individual consumer identifier such as a name which may further be associated with another generic identifier of a location or event. Such personalized souvenirs not only appeal to consumers but can further be established as point-of-sale operations complete with display systems as well as inventory management provided by an outside vendor.

While such personalized souvenirs generally enjoy wide acceptance within the industry, as well as improved sales and margins, such personalized souvenirs and programs can be easily replicated by competitors. As such there exists a strong need within the industry to continually innovate to provide consumers not only a novel personalized product, but a unique personalized experience as well.

The foregoing problems regarding conventional personalized souvenir systems and processes may represent a long-felt need for an effective solution to the same. While implementing elements may have been available, actual attempts to meet this need may have been lacking to some degree. This may have been due to a failure of those having ordinary skill in the art to fully appreciate or understand the nature of the problems and challenges involved. As a result of this lack of understanding, attempts to meet these long-felt needs may have failed to effectively solve one or more of the problems or challenges identified herein. These attempts may even have led away from the technical directions taken by the present inventive technology and may even result in the achievements of the present inventive technology being considered to some degree an unexpected result of the approach taken by some in the field.

### SUMMARY OF THE INVENTION

Primarily referring to FIGS. 1 and 2, the present inventive technology in various embodiments relates generally to a method of providing a souvenir program as in the present invention comprises the steps of contacting a souvenir retailer, providing a souvenir, preparing artwork, selecting dates and date-associated information for the personalization of the souvenir, providing a rack to the souvenir retailer for displaying the souvenir, and servicing the rack such that the rack is properly maintained. Additionally, the method of selecting dates and date-associated information for the personalization of the souvenir further comprises the steps of determining a range of dates and gathering date-associated information associated with that date. Referring to FIGS. 1 and 2 collectively, embodiments of said method of providing a souvenir further comprises the steps of providing a date-specific solar powered souvenir wherein the souvenir further comprises (i) a liquid crystal display screen, (ii) a solar panel, wherein the solar panel converts light into electrical energy, and (iii) an electronic circuit controller that receives said electrical energy and controls the liquid crystal display screen in a programmed manner. Additionally, the liquid crystal display screen is housed in a first side of the solar powered souvenir and one or more personalized artwork elements are attached to a second side of the solar powered souvenir.

The present invention is directed to a method of providing a date-specific souvenir program to a souvenir retailer. It is a further object of the present invention to provide a high sales date-specific souvenir program. It is a further object of the present invention to provide a date-specific souvenir program with continuous service. It is a further object of the present invention to provide a date-specific souvenir program that offers a personalized date-specific souvenir. It is a further object of the present invention to provide a date-specific souvenir that is novel.

The novel features that are considered characteristic of the invention are set forth with particularity in the appended claims. The invention itself, however, both as to its structure and its operation together with the additional object and advantages thereof will best be understood from the following description of the preferred embodiment of the method for providing a personalized souvenir program. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words function or means in the Description of Preferred Embodiments is not intended to indicate a desire to invoke the special provision of 35 USC § 112, paragraph 6 to define the invention. To the contrary, if the provisions of 35 USC § 112, paragraph 6 are sought to be invoked to define the invention(s), the claims will specifically state the phrases means for or step for and a function, without also reciting in such phrases any structure, material, or act in support of the function.

Moreover, even if the provisions of 35 USC § 112, paragraph 6 are invoked to define the inventions, it is intended that the inventions not be limited only to the specific structure, material or acts that are described in the preferred embodiments, but in addition, include any and all structures, materials or acts that perform the claimed function along with any and all known or later developed equivalent structures, materials, or acts for performing the claimed function.

### DESCRIPTION OF FIGURES

FIG. 1: shows a first representation of various embodiments of a method of and/or apparatus for providing date-specific personalized souvenirs.

FIG. 2: shows a second representation of various embodiments of a method of and/or apparatus for providing date-specific personalized souvenirs.

### DESCRIPTION OF THE INVENTION

The present invention includes a variety of aspects, which may be combined in different ways. The following descriptions are provided to list elements and describe some of the embodiments of the present invention. These elements are listed with initial embodiments, however it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

Generally, the inventive technology disclosed herein relates to techniques, systems, methods and apparatus for providing date-specific souvenirs that may further include personalized content which may include personalized or generalized artwork, specific consumer identifiers, date-associated information, localities, as well as to methods and apparatus for providing and servicing a date-specific personalized souvenir program. Additional embodiments also include laser engraved date-specific personalized souvenirs, as well a digital date-specific personalized souvenirs, such as solar-powered date-specific personalized souvenirs.

In one embodiment, the current invention describes a method of providing a date-specific personalized souvenir. The terms souvenir may be applied broadly to commercial products, examples of such may include, but not limited to a: a keyring souvenir; a magnet souvenir; a jewelry souvenir; a toy souvenir; a zipper pull souvenir; a keychain souvenir; a knife souvenir; a decorative box souvenir; a solar powered souvenir; a cup souvenir; a bottle souvenir; a utensil souvenir; a pen souvenir; a pencil souvenir; tablet souvenir; a case souvenir; a sporting good; a mobile phone case; a tablet computer case souvenir; wooden souvenir; a multi-tool souvenir; a wood engravable souvenir; a carabineer souvenir; a statute souvenir; a frame souvenir; a decorative souvenir, a wood blank souvenir, a solar powered device souvenir, and the like.

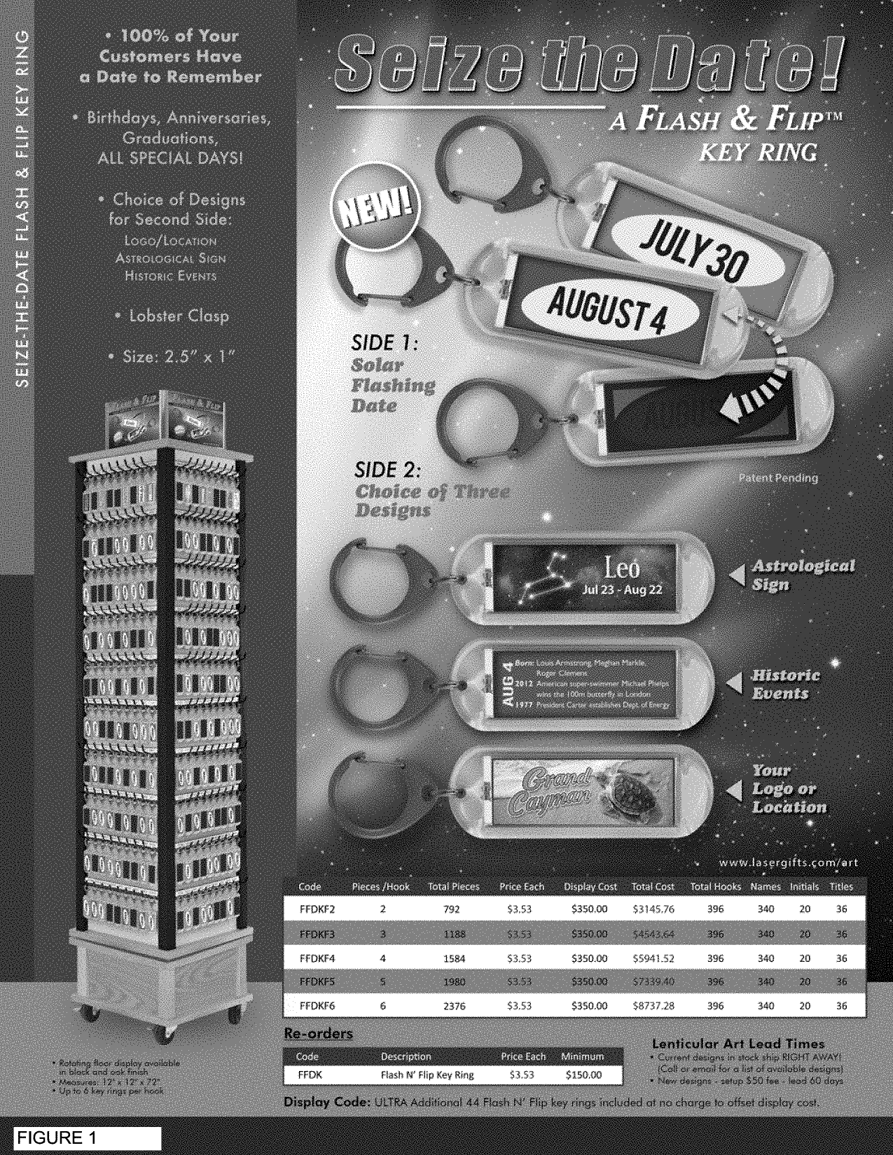

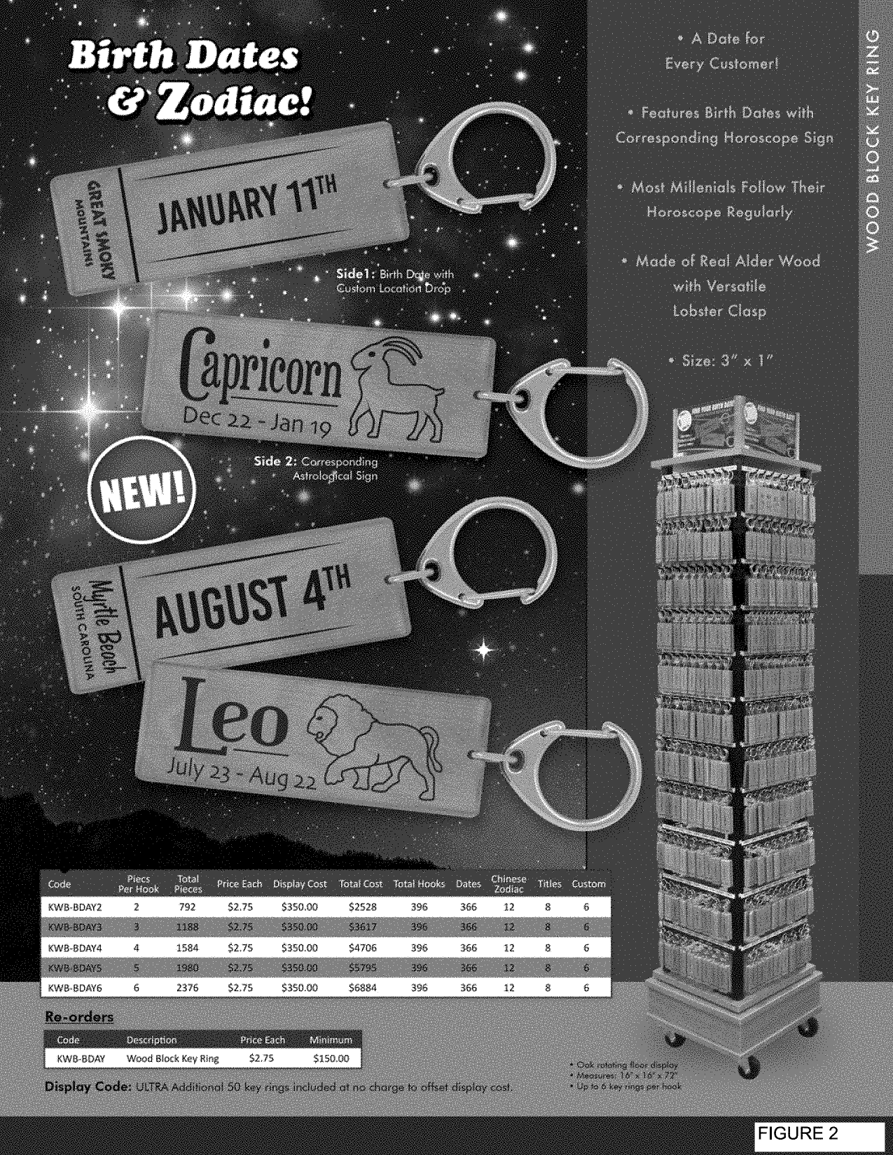

Primarily referring to FIGS. 1 and 2, the present inventive technology in various embodiments generally comprises the steps of selecting a date-specific personalized souvenir, such as a laser-engraved wood souvenir and solar powered souvenir, contacting a souvenir retailer, preparing generalized or personalized artwork, providing a rack, such as is demonstrated in the figures and to the souvenir retailer to display the p date-specific personalized souvenirs, and servicing the rack to ensure that its inventory is properly maintained perhaps involving a computer.

Preferably, the souvenirs are personalized with one or more specific dates or date ranges as is demonstrated in FIGS. 1 and 2. For example, in one embodiment a consumer may purchase, for example, a date-specific personalized souvenir, such as a keychain which may be part of a larger date-specific personalized program. Such individual personalized souvenir may contain date-specific information which may be printed on the souvenir, for example as shown in FIG. 1. In one embodiment, date-specific information may include:

Historical facts or events that occurred on the selected date or year

Zodiac information related to selected date or year

Horoscope (daily, weekly, monthly, yearly) related to selected date or year

Birth stone related to selected date or year

Birth location historical information related to selected date or year

Significant events that occurred on the selected date related to selected date or year

Famous persons with relationship to the selected date and/or event related to selected date or year

Daily affirmation and motivational sayings related to selected date or year

Daily lucky numbers, colors, lucky quote related to selected date or year

In other embodiments, a consumer may purchase a date-specific souvenir specific to a location or landmark. Such individual personalized souvenir may contain additional artwork, such as a sticker or engraved images and/or text that include:

Historical facts or events related to that location or landmark

Trivia regarding that location or landmark

Pictures of that location or landmark

Interactive media presentations of that location or landmark

Guided tours of that location or landmark

Points of interest of that location or landmark or other nearby locations or landmarks

Points of interest related to that location or landmark

In other embodiments, a consumer may purchase a date-specific souvenir specific to an event. Such individual personalized souvenir may contain additional artwork, such as a sticker or engraved images and/or text that include:

Informational presentation of that event or date of that event

Promotional materials related to that event

Contest information related to that event

Itinerary or schedule of that event

Historical facts or events related to that event

Trivia regarding that event

Pictures of the event or past similar events

It should be noted that numerous types of personalized content are contemplated in the current invention and should be construed broadly. In that sense, any specific location, event, personal characteristic, fact, game, good and/or service, direction, product, product specification, advertising, marketing material, literary work, artwork, educational information, or any general information may be tailored to constitute personalized content related to a specific souvenir, which may further be presented as artwork on the souvenir. Moreover, as discussed above, certain embodiments of the invention may encompass a personalized date-specific souvenir program which may generally comprise the steps of selecting personalized information of a souvenir such as through a computer device, contacting a souvenir retailer, preparing artwork preferably related to the personal characteristic and/or content, providing a rack to the souvenir retailer to display the personalized souvenirs, and servicing the rack to ensure that its inventory is properly maintained perhaps involving a computer.

As noted above, in some embodiments, the souvenir retailer may decide on the type of artwork that will be included on the date-specific personalized souvenirs such as a keychain. It is preferable that the artwork has a connection to the souvenir retailer's geographical location or venue. However, in an alternate embodiment, the souvenir retailer could be an organization that wishes for its logo to be depicted on the date-specific personalized souvenir. In either case, the souvenir retailer can provide the artwork to the sales representative or request that the artwork be designed by the sales representative's employer. Once the artwork is prepared, it is subject to the final approval of the souvenir retailer before the date-specific personalized souvenirs are manufactured.

In an alternate embodiment of the invention, the inventory and date-specific personalized content is electronically monitored such as with a computer device. In one embodiment, each souvenir may have a universal product code (UPC) that corresponds to, for example, the particular date on the souvenir. Every time a souvenir is purchased, the information is captured electronically such as with a computer device allowing an individual to know which dates or date ranges to re-stock. In a further alternate embodiment of the invention, the souvenirs and/or the souvenir rack includes a radio frequency identification (“RFID”) system. The RFID system aids in the supply chain management of the souvenir inventory. Specifically, this type of service can reduce the number of times a service representative actually makes a visit to a site, which ultimately increases the profit of the souvenir retailer. The information received and stored by the RFID system is transmitted to the souvenir supplier in real time such as with a computer device and provides an up to date inventory of the products on the rack.

Preferably, a sales representative contacts the souvenir retailers and provides information including pricing, samples of products, services offered, etc. Once the souvenir retailer decides to purchase the date-specific personalized souvenir program, the parties enter into a contract establishing the terms of the delivery and service of the souvenirs and the price paid by the souvenir retailer.

Primarily referring again to FIGS. 1 and 2, personalized artwork may be either non-dynamic, such as a sticker or label, or, the artwork may be dynamic such that the souvenir includes an additional liquid display screen on the second side of the souvenir wherein the additional liquid display screen alternates between transparent and opaque also denoted in FIG. 1 as “Flashing”. The artwork may be of any type including the date and date-related information selected for personalization.

When the artwork has been finalized, the souvenirs are then manufactured. Primarily referring to FIGS. 1 and 2, in a preferred embodiment, the personalized souvenirs may be acrylic key chains that include a first side and a second side. The first side houses a liquid crystal display screen, a solar panel, and an electronic circuit controller. The electronic circuit controller can be a circuit board, a triode, or any other appropriate circuit controller. The solar panel converts light into electrical energy which is then transmitted to the electronic circuit controller such that the electronic circuit controller controls the liquid crystal display screen in a programmed manner. More specifically, as seen in FIG. 1 it is preferred that the liquid crystal display screen flash between an opaque screen and a translucent screen. When the screen is translucent, the personalized date or date-specific information or other artwork is visible.

The date-specific key chain of FIGS. 1 and 2, is just one embodiment for the personalized souvenir. Alternate embodiments include zipper pulls, chokers, bracelets, and magnets to name a few. Because the souvenir is solar powered, it does not require a battery. This feature allows the souvenir to flash for an extended period of time. Further, because the souvenir is personalized, it can be used to identify the purchaser's personal items by attaching it to a set of keys, a backpack, a locker, etc.

As further seen in FIG. 1, in one embodiment of the invention, the personalized label is affixed to the back of the liquid crystal display screen. The liquid crystal display screen is placed on top of the plastic piece with a date or date range or date-related information. As stated above, when the liquid crystal display screen is opaque, the date is not visible, and when the liquid crystal display screen is translucent, the date is visible. The liquid crystal display screen flashes in a programmed manner. This means that the entire screen flashes or that the screen is partitioned and different parts flash at different times.

As seen in FIGS. 1 and 2, in another embodiment a second side of for example a key chain displays the artwork selected by the souvenir retailer. It is preferred that the artwork is also on an adhesive backed piece of paper or engraving. The paper with the artwork is adhered to the second side of the key chain. As such, the artwork and the personalized date each face different directions. Referencing again the figures, when placed for example on the rack provided to the souvenir retailer, it is important that the date side of the souvenir face the potential purchaser. Because the souvenir is date-personalized, the purchaser is searching for his or her own date, for example a date or date range that is associate with an astrological sign for example. Therefore, in certain preferred embodiments of the invention, the key chain does not have a swivel point that allows the key chain to move to the artwork side while hanging on the rack. When the sales representative comes to the souvenir retailer's place of business to provide service to the rack, it is that person's responsibility to ensure that the key chains on the rack are all oriented such that the dates, date ranges face outward.

As mentioned above, the sales representative provides an ongoing service to the souvenir retailer to maintain the souvenir retailer's inventory and aesthetic look of the display rack as shown in one embodiment in FIGS. 1 and 2. This service can be provided anywhere from two to three times a week to once a month. Due to the nature of the souvenir industry, there are some retailers that run a seasonal business (i.e., amusement parks, ski resorts, beaches, etc.). These types of retailers will not require service of their souvenir program throughout the year but may require nearly continuous service throughout their busiest season. In this type of situation, the sales representative may require additional help in providing the necessary service. This additional help can be acquired through hiring an outside contract service company that aids in maintaining the souvenir retailer's souvenir program throughout its busiest season. It is preferred to provide this high level of service to the souvenir retailer so that the souvenir program produces high sales for the souvenir retailer and in turn the sales representative's employer. In some instances, however, the servicing of the program may be performed by the customer. This may be due to special circumstances such as remote locations or point of sale systems that can track sales by date or date range.

More specifically, the alternate embodiment of the invention could include a kit for a date specific souvenir, and preferably a date-specific personalized souvenir program that comprises a word or solar powered souvenir having a selected date wherein, in the case of the solar powered souvenir, it comprises 1) a liquid crystal display screen for displaying the selected date or date range; 2) a solar panel, wherein the solar panel converts light into electrical energy; 3) an electronic circuit controller, wherein the electronic circuit controller receives the electrical energy and controls the liquid crystal display screen in a programmed manner; 4) housing said liquid crystal display screen in a first side of the solar powered souvenir with the date or date range wherein the liquid crystal display screen alternates between transparent and opaque such that the date or date range is dynamically displayed; 5) including artwork on a second side of the souvenir; and 6) an inventory monitoring device. In addition, the kit for the personalized solar powered souvenir program can include a rack to display an inventory of the date-specific souvenir and a computer device.

It is preferred in an alternate embodiment that the inventory monitoring device of the kit for the date-specific souvenir program is electronic such as involving a computer device. Moreover, the electronic inventory monitoring device is preferably a radio frequency identification system where the radio frequency identification system transmits the inventory information to a receiver that is located on the rack. An individual then preferably monitors the receiver on the said rack in order to maintain the inventory. Alternatively, the electronic inventory monitoring device is preferably a radio frequency identification system where the radio frequency identification system transmits the inventory information to a receiver that is located at either a portable or fixed location within transmitting distance. An individual then preferably monitors the receiver in order to maintain the inventory. In a further alternate embodiment, the inventory monitoring device is a universal product code that is coupled to the date-specific souvenir, and preferably a date-specific personalized souvenir. In this embodiment, a unique universal product code corresponds to each personalized date such that the inventory is computer monitored upon a souvenir being purchased. The use of a radio frequency identification system and Universal Product Code as the inventory monitoring device are just two embodiments. In fact, the inventory monitoring device could be a computer device or any type of device or system that efficiently tracks and manages the souvenir inventory.

Naturally as can be appreciated, all of the steps as herein described may be accomplished in some embodiments through any appropriate machine and/or device resulting in the transformation of, for example date-specific souvenir configuration, data, personalized content, inventory content and presentation as well as personalized characteristics. It should also be noted that in some instances software and/or software solution may be utilized to carry out the objectives of the invention and may be defined as software stored on a magnetic or optical disk or other appropriate physical computer readable media including wireless devices and/or smart phones. In alternative embodiments the software and/or data structures can be associated in combination with a computer or processor that operates on the data structure or utilizes the software. Further embodiments may include transmitting and/or loading and or updating of the software on a computer perhaps remotely over the internet or through any other appropriate transmission machine or device, or even the executing of the software on a computer resulting in the data and/or other physical transformations as herein described.

Certain embodiments of the inventive technology may utilize a machine and/or device which may include a general purpose computer, a computer that can perform an algorithm, computer readable medium, software, computer readable medium continuing specific programming, a computer network, a server and receiver network, transmission elements, wireless devices and/or smart phones, internet transmission and receiving element; software updateable elements; computer routines and or subroutines, computer readable memory, data storage elements, random access memory elements, and/or computer interface displays that may represent the data in a physically perceivable transformation such as visually displaying said processed data. In addition, as can be naturally appreciated, any of the steps as herein described may be accomplished in some embodiments through a variety of hardware applications including a keyboard, mouse, computer graphical interface, voice activation or input, server, receiver and any other appropriate hardware device known by those of ordinary skill in the art.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the statements of invention. As can be easily understood from the foregoing, the basic concepts of the present invention may be embodied in a variety of ways. It involves both techniques as well as devices to accomplish the appropriate system for providing personalized souvenirs and the like. In this application, the instrument sterilization techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in method-oriented terminology, each element of the claims corresponds to a device. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting any claims. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “display” should be understood to encompass disclosure of the act of “displaying”—whether explicitly discussed or not—and, conversely, were there effectively disclosure of the act of “displaying”, such a disclosure should be understood to encompass disclosure of a “displaying method and/or technique, and or device.” Such changes and alternative terms are to be understood to be explicitly included in the description.

Any patents, publications, or other references mentioned in this application for patent are hereby incorporated herein by reference in their entirety. Any priority case(s) claimed by this application is hereby appended and hereby incorporated herein by reference in their entirety. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated herein by reference in their entirety. Finally, all references listed in the list of References To Be Incorporated By Reference In Accordance With The Patent Application or other information disclosure statement and the like filed with the application are hereby appended and hereby incorporated herein by reference in their entirety, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the system (with corresponding methods and apparatus) of providing date-specific souvenirs as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, xii) each potentially dependent claim or concept as a dependency on each and every one of the independent claims or concepts presented, and xiii) all inventions described herein.

In addition and as to computer aspects and each aspect amenable to programming or other electronic automation, the applicant(s) should be understood to have support to claim and make a statement of invention to at least: xvi) processes performed with the aid of or on a computer and or controller as described throughout the above discussion, xv) a programmable apparatus as described throughout the above discussion, xvi) a computer readable memory encoded with data to direct a computer comprising means or elements which function as described throughout the above discussion, xvii) a computer configured as herein disclosed and described, xviii) individual or combined subroutines and programs as herein disclosed and described, xix) the related methods disclosed and described, xx) similar, equivalent, and even implicit variations of each of these systems and methods, xxi) those alternative designs which accomplish each of the functions shown as are disclosed and described, xxii) those alternative designs and methods which accomplish each of the functions shown as are implicit to accomplish that which is disclosed and described, xxiii) each feature, component, and step shown as separate and independent inventions, and xxiv) the various combinations and permutations of each of the above.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 20 or any other claim” or the like, it could be re-drafted as dependent on claim 1, claim 15, or even claim 715 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon. The inventive subject matter is to include, but certainly not be limited as, a system substantially as herein described with reference to any one or more of the Figures and Description (including the following: for example, the process according to any claims and further comprising any of the steps as shown in any Figures, separately, in any combination or permutation).

What is claimed is:

1. A method of providing a multitude of souvenir devices through a composite presentation comprising the steps of:
contacting a personalized solar powered devices retailer;
establishing a multitude of personalized solar powered programmed souvenir devices;
selecting a date and/or date ranges for each of said personalized solar powered programmed souvenir devices
having each of said personalized solar powered programmed souvenir devices manufactured to electronically transform and dynamically display at least one of said selected dates or date ranges;
presenting said multitude of personalized solar powered devices in a manner that said personalized solar powered devices present a composite appearance that electronically transforms and dynamically displays a multitude of said selected dates or date ranges;
configuring said multitude of personalized solar powered programmed souvenir devices to each accomplish the steps of:
displaying a selected dates or date ranges through a liquid crystal display screen;
utilizing a solar panel, wherein said solar panel converts light into electrical energy; and
electronically controlling an electronic circuit, wherein said electronic circuit receives said electrical energy and controls said liquid crystal display screen to transform in a programmed and dynamic manner; and
housing said liquid crystal display screen on at least a first side of each of said solar powered programmed souvenir devices with said dates or date ranges wherein said liquid crystal display screen alternates between transparent and opaque such that said date or date range is dynamically displayed; and
g. continuously maintaining said composite appearance with use of a computer device wherein each said personalized solar powered programmed souvenir device is frequently replenished so as to create a uniform and distinct dynamically transformative composite display when exposed to light.

2. A method of providing a multitude of souvenir devices through a composite presentation as described in claim 1 wherein said step of selecting dates or date ranges for each of said personalized solar powered programmed souvenir devices using a computer to identify percentage of the population born on one or more specific dates.

3. A method of providing a multitude of souvenir devices through a composite presentation as described in claim 1 wherein said step of selecting dates or date ranges for each of said personalized solar powered programmed souvenir devices further comprises the step of using an date range appropriate for said selected souvenir.

4. A method of providing a multitude of souvenir devices through a composite presentation as described in claim 1 wherein said step of selecting date or date range for each of said personalized solar powered programmed souvenir devices further comprises the step of using an date range corresponding to one or more Zodiac symbol ranges.

5. A method of providing a multitude of souvenir devices through a composite presentation as described in claim 4 wherein said step of selecting date or date ranges for each of said personalized solar powered programmed souvenir devices further comprises a step selected from a group consisting of:
including at least some date-specific personalized solar powered programmed souvenir devices displaying date-range specific information on said solar powered programmed souvenir devices,
including at least some date-specific personalized solar powered programmed souvenir devices displaying date-specific information on said solar powered programmed souvenir devices, and
including both at least some date-specific personalized solar powered programmed souvenir devices displaying date-range specific information on said solar powered programmed souvenir devices and at least some date-specific personalized solar powered programmed souvenir devices displaying at least some date-specific information on said solar powered programmed souvenir devices.

6. A method of providing a multitude of souvenir devices through a composite presentation as described in claim 1 wherein said step of providing a multitude of date-specific personalized solar powered programmed souvenir devices comprises a step selected from a group consisting of:
displaying at least 12 different date-ranges on said multitude of solar powered programmed souvenir devices, and
displaying at least 356 hundred different dates on said multitude of solar powered programmed souvenir devices.

7. A method of providing a multitude of souvenir devices through a composite presentation as described in claim 1 wherein said step of providing a date-specific multitude of personalized solar powered programmed souvenir devices comprises the step of maintaining about date-specific fifteen times more of the date-range personalized solar powered programmed souvenir devices containing date ranges than any single date-specific souvenir device.

8. A method of providing a multitude of souvenir devices through a composite presentation as described in claim 1 and further comprising the step of including geographical location artwork on a second side of said date-specific powered programmed souvenir device.

9. A method of providing a multitude of souvenir devices through a composite presentation as described in claim 1 and further comprising the step of including a retailer's business logo on a second side of said date-specific powered programmed souvenir device.

10. A method of providing a multitude of souvenir devices through a composite presentation as described in claim 1 and further comprising the step of non-swivelably hanging said multitude of date-specific personalized solar powered programmed souvenir devices on said personalized solar powered device rack.

11. A method of providing a multitude of souvenir devices through a composite presentation as described in claim 1 wherein said step of providing a multitude of date-specific personalized programmed souvenir devices comprises a step selected from a group consisting of:
establishing a multitude of date-specific personalized programmed zipper pull souvenir devices,
establishing a multitude of date-specific personalized programmed magnet souvenir devices,
establishing a multitude of date-specific personalized programmed choker souvenir devices,
establishing a multitude of date-specific personalized programmed bracelet souvenir devices,
establishing a multitude of date-specific personalized programmed wood souvenir devices,
establishing a multitude of date-specific personalized programmed key ring souvenir devices, and
establishing a multitude of date-specific personalized programmed key chain souvenir devices.

12. A method of providing a multitude of souvenir devices through a composite presentation as described in claim 8 wherein said step of including geographical location artwork on a second side of said date-specific programmed souvenir device comprises a step selected from a group consisting of:
including amusement facility artwork on a second side of said solar powered programmed souvenir device,
including park artwork on a second side of said solar powered programmed souvenir device,
including resort artwork on a second side of said solar powered programmed souvenir device,
including beach locale artwork on a second side of said solar powered programmed souvenir device, and
including seasonal business artwork on a second side of said solar powered programmed souvenir device.

13. A method of providing a multitude of souvenir devices through a composite presentation as described in claim 1 wherein said step of continuously maintaining said date-specific personalized device rack with use of a computer device comprises the step of utilizing outside contractor services for at least part of the time.

14. A method of providing a multitude of souvenir devices through a composite presentation as described in claim 13 wherein said step of utilizing outside contractor services for at least part of the time comprises the step of seasonally utilizing outside contractor services for at least part of the time.

15. A method of providing a multitude of souvenir devices through a composite presentation as described in claim 1 wherein said step of continuously maintaining said date-specific personalized solar powered device rack with use of a computer device comprises a step selected from a group consisting of:
about twice weekly maintaining said personalized solar powered device rack to create a uniform and distinct dynamically transformative display when exposed to light,
about thrice weekly maintaining said personalized solar powered device rack to create a uniform and distinct dynamically transformative display when exposed to light,
about monthly maintaining said personalized solar powered device rack to create a uniform and distinct dynamically transformative display when exposed to light, and
seasonally varying the frequency of maintaining said personalized solar powered device rack to create a uniform and distinct dynamically transformative display when exposed to light.

16. A method of providing a multitude of souvenir devices through a composite presentation as described in claim 1 wherein said step of continuously maintaining said date-specific personalized solar powered device rack with use of a computer device comprises the step of continuously maintaining said rack by an electronic monitoring system.

17. A method of providing a multitude of souvenir devices through a composite presentation as described in claim 16 wherein said step of continuously maintaining said rack by an electronic monitoring system comprises the step of tying to a retailer's point of sale computer system.

18. A method of providing a multitude of souvenir devices through a composite presentation as described in claim 1 wherein said step of displaying a selected date or date range through a liquid crystal display screen comprises the step of displaying a selected date or date range through a partitioned display liquid crystal display screen.

19. A method of providing a multitude of souvenir devices through a composite presentation as described in claim 18 wherein said step of electronically controlling an electronic circuit, wherein said electronic circuit receives said electrical energy and controls said liquid crystal display screen to transform in a programmed and dynamic manner comprises the step of electronically controlling said partitioned display liquid crystal display screen to display each partition differently.

20. A method of providing a multitude of souvenir devices through a composite presentation as described in claim 1 and further comprising the step of allowing said personalized solar powered devices retailer to select additional date ranges or date-specific information to include in said multitude of personalized solar powered programmed souvenir devices.
